(19) United States
(12) Patent Application Publication
(10) Pub. No.: US 2019/0191636 A1
(43) Pub. Date: Jun. 27, 2019

(54) PLANT PROTECTION DEVICE

(71) Applicant: Ronnie Livingston, SR., Homewood, IL (US)

(72) Inventor: Ronnie Livingston, SR., Homewood, IL (US)

(21) Appl. No.: 16/231,003

(22) Filed: Dec. 21, 2018

Related U.S. Application Data
(60) Provisional application No. 62/608,786, filed on Dec. 21, 2017.

(51) Int. Cl. A01G 13/04; A01G 13/10

(52) U.S. Cl. CPC A01G 13/043; A01G 2013/006; A01G 13/10

(57) ABSTRACT

A plant protection device comprising a durable screen-like mesh pop-up covering structured and arranged to be placed over tomato plants and their supporting cages as well as other caged plants and seedling trees, to protect them from animals and insects.

### CROSS-REFERENCE TO RELATED APPLICATION

The present application is related to and claims priority from prior provisional application Ser. No. 62/608,786, filed Dec. 21, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of protector devices and more specifically relates to a plant protection device comprising a durable screen-like mesh pop-up covering structured and arranged to be placed over tomato plants and their supporting cages as well as other caged plants and seedling trees, to protect them from animals and insects.

### 2. Description of the Related Art

Among the joys of home ownership is that of having a yard. Our own patch of ground, be it large or small, gives us a piece of nature to tend, to improve as we wish. For some, this will mean planting bushes and flowers that attract birds and butterflies; for others, planting a vegetable garden to help feed the family with fresh and wholesome, home-grown produce; for others, the chance to cultivate a lawn and landscape as smooth and green as the felt on a pool table, with here and there a stand of trees or border of bushes. But for every homeowner, the joy of having a yard and garden comes with the responsibility of tending it. Mowing the grass, trimming the borders, clipping the bushes and hedge; watering the grass and flowerbeds; planting the appropriate plants and flowers at the appropriate times and in the appropriate places; using fertilizers, pesticides, and herbicides properly and responsibly: these are only a few of the responsibilities that come with having a yard.

If keeping up a yard and garden comes with both pleasure and responsibility, it also comes with plenty of ready-made enemies. Moles and grubs attack from beneath; insects attack from above—and animals like deer and rabbits, whom we enjoy until we see them eat up our gardens—are a constant threat to the plants we cultivate and nurture. Therefore, a need exists for a plant protection device to thwart the efforts of animals to eat and destroy our plants not by poisoning them or thwarting their appetites, but by preventing them access

Various attempts have been made to solve problems found in plant protector device art. Among these are found in: U.S. Pat. No. 5,359,810 to Debbie J. Aul; U.S. Pat. No. 5,412,905 to Ian T. Allison; and U.S. Pat. No. 6,088,953 to Wayne Morgan. This prior art is representative of plant covers that protect against insects, animals, inclement weather, and the.

Ideally, a plant protection device should be user-friendly and safe in-use and yet would operate reliably and be manufactured at a modest expense. Thus, a need exists for a plant protection device comprising a durable screen-like mesh pop-up covering structured and arranged to be placed over tomato plants and their supporting cages as well as other caged plants and seedling trees, to protect them from animals and insects and to avoid the above-mentioned problems.

### BRIEF SUMMARY OF THE INVENTION

In view of the foregoing disadvantages inherent in the known of protector device art, the present invention provides a novel Plant Protection Device. The general purpose of the present invention, which will be described subsequently in greater detail is to provide a plant protection device comprising a durable screen-like mesh pop-up covering structured and arranged to be placed over tomato plants and their supporting cages as well as other caged plants and seedling trees, to protect them from animals and insects.

A plant protection device comprising: a screen member and a plurality of spikes. The screen member includes an edge portion and a plurality of apertures. Wherein said edge portion is adapted to be placed and held upon on a ground surface. Wherein the plurality of apertures are spaced from one another and located through said edge portion. Wherein said screen member is shaped to form an interior volume and adapted to fit over a plant in a garden, such that the plant can be located substantially within the interior volume. Wherein each of the plurality of spikes are adapted to releasably engage a respective one of the plurality of apertures and be pushed through the ground surface, to thereby removably secure the screen member to the ground surface and around the plant.

The present invention holds significant improvements and serves as a plant protection device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Plant Protection Device, constructed and operative according to the teachings of the present invention.

FIG. 1 shows a perspective view illustrating a Plant Protection Device in an in-use condition according to an embodiment of the present invention.

FIG. 2 is a perspective view illustrating a screen member and a plurality of spikes of the Plant Protection Device according to an embodiment of the present invention of FIG. 1.

FIG. 3 is a perspective view illustrating the plurality of spikes of the Plant Protection Device according to an embodiment of the present invention of FIG. 1.

FIG. 4 is a perspective view illustrating the Plant Protection Device having a plant cage according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a protector device and more particularly to a plant protection device comprising a durable screen-like mesh pop-up covering structured and arranged to be placed over tomato plants and their supporting cages as well as other caged plants and seedling trees, to protect them from animals and insects.

Generally speaking, the Plant Protection Device comprises a specially designed lightweight and durable, flexible plastic-mesh bag or sack designed to slip easily over a metal tomato cage—or over a variety of other cage-supported plants such as peppers, peas, beans, and cucumbers, as well as immature shrubs and tree seedlings in order to protect the plants from insect and animal pests.

The Plant Protection Device is preferably fabricated in a durable screen-like mesh, fine enough to prevent the passage of insect pests, yet not so fine as to prevent the passage of sunlight and rainwater. The standard Plant Protection Device is intended for use with a standard tomato cage, would measure 33 inches in height by 12 inches in diameter. The Plant Protection Device may also be produced in larger sizes, as plant support cages do vary somewhat in height—42-, 48-, and 54-inch cages, for example—and in width. Further, the Plant Protection Device may be produced in a variety of colors, perhaps coded according to the specific plants protected: possibilities here would include red for tomatoes; green for beans; yellow for peppers. A pop-up unit, the Plant Protection Device would be secured at the bottom of the plant supporting cage by means of four metal stakes driven into the ground through the four grommets located at the bottom of the mesh covering; and, the collapsible Plant Protection Device would be substantial enough in construction to be stored flat when not in use, and last for multiple growing seasons. Further, the Plant Protection Device may include a zipper on at least one seam for ease of placing the mesh screen over a plant or for accessing the plant when the screen is in use.

Should the Plant Protection Device cover be a successful product, it might be followed with a product line of Plant Protection Device plant-support cages, the cages and pop-up cover then sold in sets. (The Plant Protection Device kits could include four protective coverings each with four grommet holes). The Plant Protection Device will also feature a zipper to allow for easy plant access and harvesting. The Plant Protection Device may provide an effective barrier between plant and pest, yet allow the plant to receive rain, carbon dioxide, and sunlight, and thus continue to grow and prosper.

The Plant Protection Device may be produced in a range of sizes to fit the most popular plant-support cages on the market, and this versatile gardening accessory would be useful not only for protecting vegetables, but also for protecting young fruit and ornamental trees. The Plant Protection Device may be easily affordable, paying for itself in terms of the produce protected and saved by its use. Further, because The Plant Protection Device takes a physical-barrier approach to pest prevention, no costly pesticides or other potentially damaging chemicals would be involved or required. This will eliminate not only the added expense of chemicals, but also the potential health hazards from using these chemicals, thus producing organic crops and plants. An environmentally friendly, “green” product, The Plant Protection Device may simply place a vulnerable plant in a protective mesh shell, thus frustrating the attempts of deer, rabbits, and other animal and insect pests to get at it. Effective, economical, and environmentally friendly, The Plant Protection Device should find a wide and enthusiastic market among the gardeners of America and the world

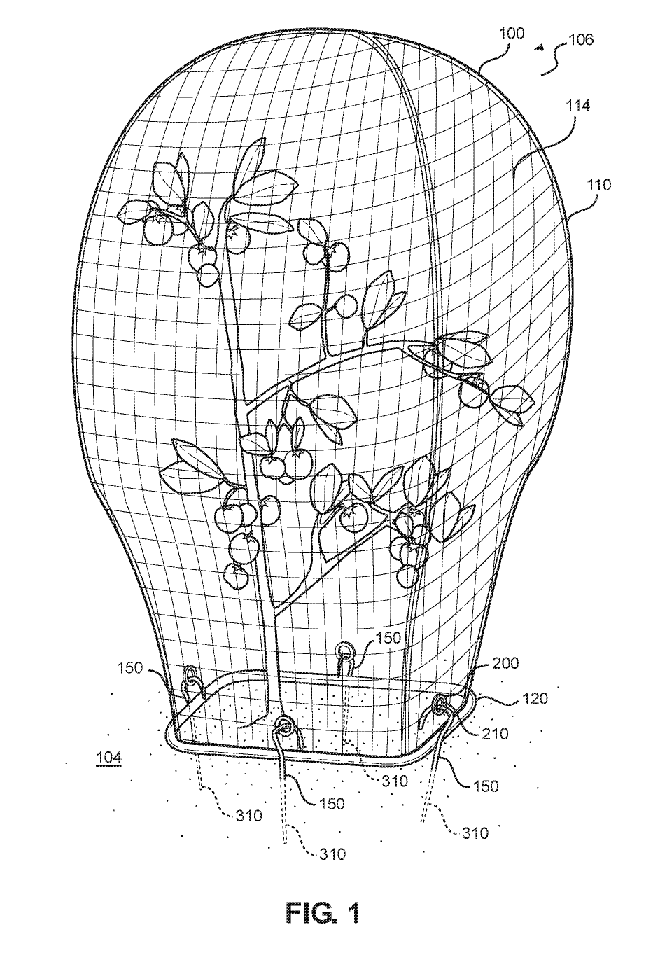

Referring to the drawings by numerals of reference there is shown in FIGS. 1-4, perspective views illustrating plant protection device 100 according to an embodiment of the present invention.

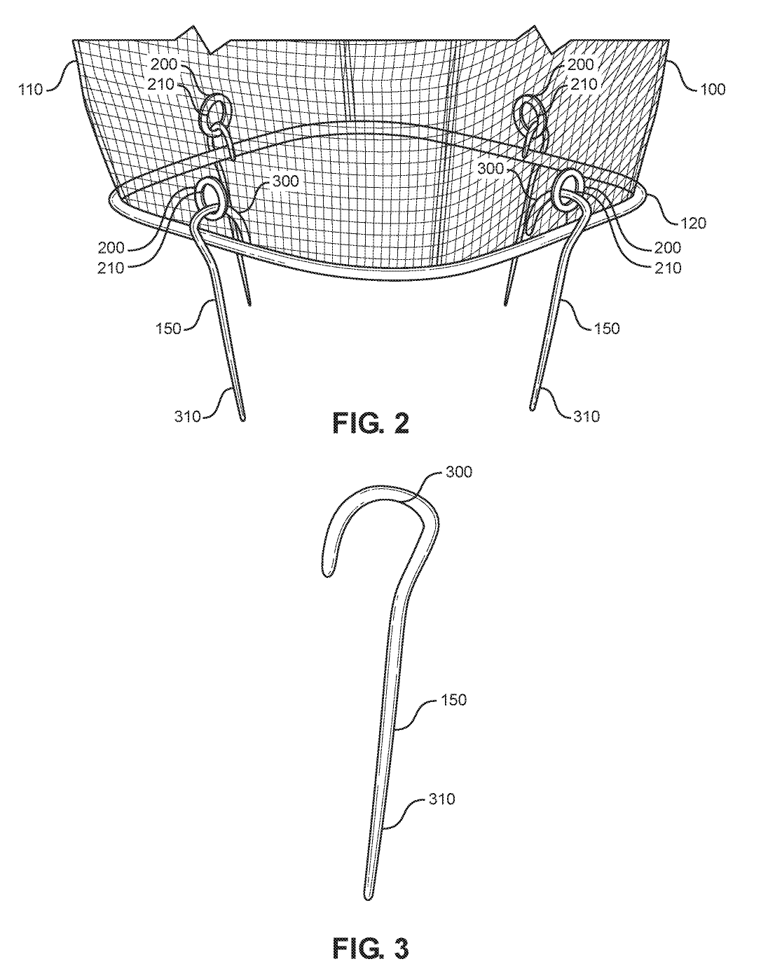

Plant protection device 100 comprises: screen member 110 and plurality of spikes 150. Screen member 110 includes edge portion 120 and plurality of apertures 200. Wherein edge portion 120 is adapted to be placed and held upon on ground surface 104 as shown in in-use condition 106 of FIG. 1. Wherein edge portion 120 is formed from a semi-rigid material and is formed having a rectangular shape as shown in FIG. 1. Wherein edge portion 120 is formed from a semi-rigid material and is formed having a circular shape as shown in FIG. 2. Wherein plurality of apertures 200 are spaced from one another and located through edge portion 120 as shown in FIG. 2. Wherein screen member 110 is shaped to form interior volume 114 and adapted to fit over a plant in a garden, such that the plant can be located substantially within interior volume 114 as shown in in-use condition 106 of FIG. 1. Wherein each of plurality of apertures 200 includes grommet 210 there around.

Wherein screen member 110 is formed from a mesh material. wherein grommets 134 are formed from a material chosen from a list of materials consisting of aluminum, brass, and plastic Wherein screen member 110 is color-coded 116 to represent the type of plant it is protecting, wherein red is for tomatoes, green is for beans, and yellow is for peppers. Wherein screen member 110 is formed from a material chosen from a list of materials consisting of aluminum, nylon, and plastic.

Wherein each of plurality of spikes 150 are adapted to releasably engage a respective one of plurality of apertures 130 and be pushed through the ground surface, to thereby removably secure the screen member to ground surface 104 and around the plant. Wherein each of said plurality of spikes 150 are each formed having curved section 300 adapted to releasably engage a respective one of plurality of apertures 200 as shown in FIG. 3. Wherein each of plurality of spikes 150 are each formed having straight section 310 adapted to be pushed through ground surface 104 also shown in FIG. 3. Wherein plurality of spikes 150 are formed from a metallic material. Wherein there are four apertures 200 and four spikes 150 as shown best in FIG. 2.

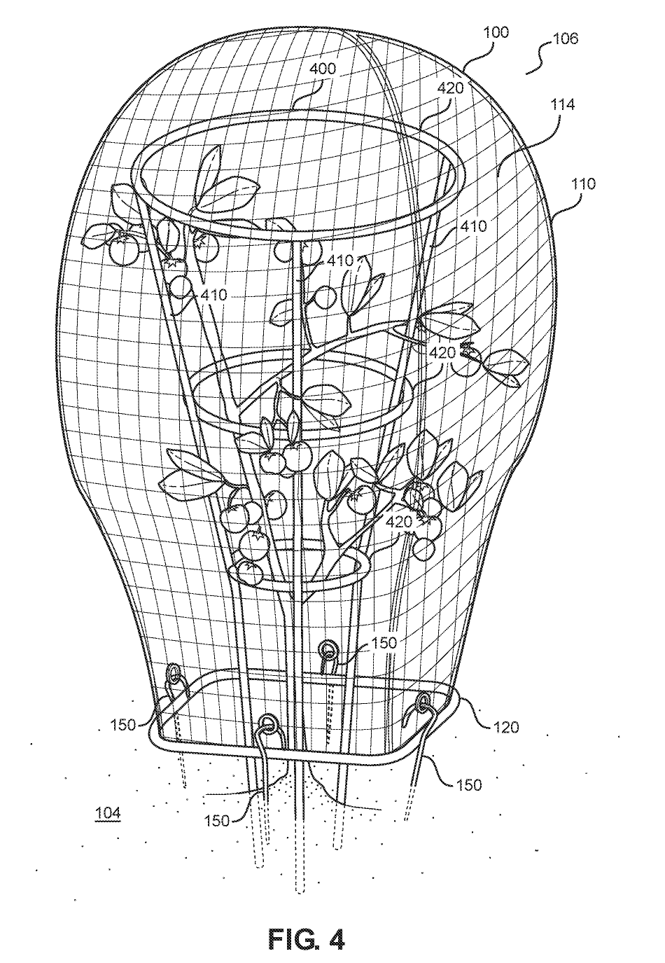

Plant protection device 100 further comprising plant cage 400 adapted to hold a plant in an erect position, is adapted to fit within screen member 110, and includes: plurality of vertical wires 410 and plurality of rings 420 as shown in FIG. 4. Wherein plurality of vertical wires 410 are spaced from one another, have substantially equal lengths, and are adapted to be pushed through ground surface 104 to thereby removably secure plant cage 400 to ground surface 104 and around the plant. Wherein plurality of rings 420 are spaced from one another and respectively attached to each of vertical wires 410 to thereby form plant cage 400. Wherein plant cage 400 is formed having a height chosen from a list of heights consisting of 33 inches, 42 inches, 48 inches, and 54 inches. Wherein plant cage 400 is formed having a diameter of 12 inches.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A plant protection device comprising:
a screen member including:
an edge portion;
wherein said edge portion is adapted to be placed and held upon on a ground surface;
a plurality of apertures;
wherein said plurality of apertures are spaced from one another and located through said edge portion;
wherein said screen member is shaped to form an interior volume and adapted to fit over a plant in a garden, such that said plant can be located substantially within said interior volume;
a plurality of spikes;
wherein each of said plurality of spikes are adapted to releasably engage a respective one of said plurality of apertures and be pushed through said ground surface, to thereby removably secure said screen member to said ground surface and around said plant.

2. The plant protection device of claim 1, wherein each of said plurality of apertures includes a grommet there around.

3. The plant protection device of claim 1, wherein said each of said plurality of spikes are each formed having a curved section adapted to releasably engage a respective one of said plurality of apertures.

4. The plant protection device of claim 3, wherein said each of said plurality of spikes are each formed having and a straight section adapted to be pushed through said ground surface.

5. The plant protection device of claim 1, wherein there are four apertures and four spikes.

6. The plant protection device of claim 1, wherein said edge portion is formed from a semi-rigid material and is formed having a rectangular shape.

7. The plant protection device of claim 1, wherein said edge portion is formed from a semi-rigid material and is formed having a circular shape.

8. The plant protection device of claim 1, wherein said screen member is formed from a mesh material.

9. The plant protection device of claim 1, wherein said plurality of spikes are formed from a metallic material.

10. The plant protection device of claim 1, wherein said screen member is color-coded to represent the type of plant it is protecting, wherein red is for tomatoes, green is for beans, and yellow is for peppers.

11. The plant protection device of claim 1, further comprising a plant cage adapted to hold a plant in an erect position, is adapted to fit within said screen member, and includes:
a plurality of vertical wires;
wherein said plurality of vertical wires are spaced from one another, have substantially equal lengths, and are adapted to be pushed through said ground surface to thereby removably secure said plant cage to said ground surface and around said plant; and
a plurality of rings;
wherein said plurality of rings are spaced from one another and respectively attached to each of said vertical wires to thereby form said plant cage.

12. The plant protection device of claim 11, wherein said plant cage is formed having a height chosen from a list of heights consisting of 33 inches, 42 inches, 48 inches, and 54 inches.

13. The plant protection device of claim 11, wherein said plant cage is formed having a diameter of 12 inches.

14. The plant protection device of claim 1, wherein said screen member is formed from a material chosen from a list of materials consisting of aluminum, nylon, and plastic.

15. The plant protection device of claim 8, wherein said grommets are formed from a material chosen from a list of materials consisting of aluminum, brass, and plastic.
